(19) United States
(12) Patent Application Publication
(10) Pub. No.: US 2008/0288217 A1
(43) Pub. Date: Nov. 20, 2008

(54) Data Logging Method

(75) Inventor: Tokunobu Akao, Toyama-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., TOKYO (JP)

(21) Appl. No.: 11/990,849

(22) PCT Filed: Sep. 21, 2006
(86) PCT No.: PCT/JP2006/318688

§ 371 Date: Apr. 14, 2008

(30) Foreign Application Priority Data
Sep. 27, 2005 (JP) 2005-279569

(51) Int. Cl. G06F 17/40

(52) U.S. Cl. 702/187

(57) ABSTRACT

The invention relates to the acquisition of log data in an apparatus such as a substrate processing apparatus. The invention permits detailed data related to a premonitory phenomenon preceding the occurrence of an alarm condition to be acquired without increasing the amount of data. A data logging method of the invention has a constitution wherein a difference between the maximum value and the minimum value of the acquired data is determined, wherein a first segment of the acquired data is stored if the difference is not less than a preset value, and if the difference is less than the preset value, a second portion included in the first segment of the acquired data is stored.

### TECHNICAL FIELD

The present invention relates to a data logging method for sequentially logging the operational status of an apparatus. The invention relates to, for example, the data logging method for sequentially logging production data and such in a case where semiconductors are manufactured by a substrate processing apparatus.

### BACKGROUND ART

As one of processing steps for manufacturing semiconductor device, a substrate processing step is known wherein processes including thin film deposition, impurity diffusion, annealing, etching and the like are performed on a substrate such as a glass substrate or silicon wafer (hereinafter, referred to as “wafer”). These processes are carried out by the substrate processing apparatus.

The substrate processing apparatus is provided with a data logging device for trace logging in the interest of product control or investigation into cause in the event of faulty processing.

The data logging apparatus is adapted to log manufacture data at a given time interval when the wafer is processed, the data including, for example, substrate temperature, flow rate of a processing gas, pressure in a process chamber and the like during film deposition; to record data (log data) on the previous conditions of the apparatus and on time-varying processing conditions; and to present graphical display of the log data via predetermined display means in response to an operator's request or on a steady basis.

The log data is sequentially recorded in a storage device, such as a hard disk, provided at semiconductor manufacturing equipment.

The hard disk has a limited capacity. If the file size of the log data processed in one wafer processing step is large, the hard disk is able to store a decreased number of previous log data files. It is therefore preferred that the logging file has a smaller size.

It has been a conventional practice to take a procedure including the steps of: deciding how many files of data on the previously performed wafer processing are stored; determining the size of a logging file by inverse operation based on the capacity of the storage device; and selecting logging items and deciding an interval (cycle) to acquire the log data so that the volume of the log data may be smaller than the size of the logging file.

Assumed that log data points acquired in one processing step is 1500 points, for example, the logging is performed at hours/1500 points in order to log all the data related to a 12-hours' substrate processing and hence, the logging cycle is set to 30 seconds.

In this case, the following problem exists. If some abnormality occurs in the course of the processing and an operator wants to refer to the data to grasp the details of the abnormal state, only the log data sampled at the 30-second interval is available, which is far from being adequate for meeting the reference purpose. In this connection, a method has been contemplated which permits detailed data to be acquired in the event of abnormality or during the processing without increasing the total volume of the log data.

From the viewpoint of intended purpose, the log data is not always required to be sampled at short intervals. Only in some cases where, for example, some abnormality occurs in the substrate processing apparatus, or where the apparatus is in a certain condition when the processing is performed or such, the log data sampled at short intervals is required. Therefore, the following method is adopted in the art. The data acquiring interval is not set short in the overall logging process. Rather, a long log-data acquiring interval is adopted unless an alarm is actuated to alert the operator to some abnormality of the apparatus or the substrate processing is performed, whereby the amount of the log data is reduced (thinned out).

Currently, there is a demand to use the log data in an operation such as failure prognosis or failure diagnosis. In order to meet such a demand, it is necessary to provide a measure to detect any potential abnormality from the log data before the apparatus sustains an alarm condition.

In the event of an abnormality of the apparatus, the event is normally preceded by a premonitory phenomenon, wherein log data presents a value which is different from that when the apparatus is in a proper working condition but which falls below an alarm detection level.

A constitution is made such that a detection value such as of a gas flow rate or processing pressure, which temporarily reaches an abnormal level, is not determined to reach the alarm detection level unless the detection value maintains the abnormal level for a certain period of time. Accordingly, an alarm signal is not generated in a case where the detection value momentarily exceeds the alarm detection level or where the fluctuations of the detection value are greater than those when the apparatus is in the proper working condition but are in an allowable range.

According to the conventional log data acquisition method, the interval to acquire the log data in the state where the alarm condition is undetected is long. It is therefore difficult to detect the aforementioned premonitory phenomenon preceding the occurrence of the alarm condition from the log data.

### DISCLOSURE OF THE INVENTION

### Problems to Be Solved by the Invention

In view of the foregoing, the invention is directed to the acquisition of the log data on the apparatus such as the substrate processing apparatus, or to permit detailed data on the premonitory phenomenon preceding the occurrence of the alarm condition to be acquired without increasing the amount of data.

### Means for Solving the Problem

According to a first aspect of the invention, a data logging method is characterized in that a difference between the maximum value and the minimum value of acquired data pieces is determined; that a first segment of the acquired data pieces is stored if the difference is not less than a preset value; and that if the difference is less than the preset value, a second portion of the first segment of the acquired data pieces is stored.

According to a second aspect of the invention, a data logging method is characterized in that data acquired from an apparatus is stored in a first storage portion; that a difference between the maximum value and the minimum value of the data pieces collected in the first storage portion at a predetermined time interval is determined; that a first segment of the collected data pieces is stored in a second storage portion if the difference is not less than a preset value; and that if the difference is less than the preset value, a second portion of the first segment of the collected data pieces is stored in the second storage portion.

According to a third aspect of the invention, a data logging method is characterized in that a time interval to permit a first storage portion to assess data acquired at least from an apparatus is defined; that a difference between the maximum value and the minimum value of the plural data pieces collected in the first storage portion at the time interval thus defined is determined; that a first segment of the collected data pieces is stored in a second storage portion if the difference is not less than a preset value; and that if the difference is less than the preset value, a second portion of the first segment of the collected data pieces is stored in the second storage portion.

According to a fourth aspect of the invention, a data logging method is characterized in that a cycle to acquire data at least from an apparatus and a time interval to permit a first storage portion to assess the data acquired from the apparatus are defined; that the data piece acquired in each cycle thus defined is stored in the first storage portion; that a difference between the maximum value and the minimum value of the plural data pieces stored in the first storage portion is determined at each time interval thus defined; that a first segment of the collected data pieces is stored in a second storage portion if the difference is not less than a preset value, and that if the difference is less than the preset value, a second portion of the first segment of the collected data pieces is stored in the second storage portion.

### EFFECTS OF THE INVENTION

The invention offers the following excellent effects. The difference between the maximum value and the minimum value of the acquired data pieces is determined in order that the abnormality of the acquired data may be detected by determining the variations of the acquired data pieces on a per-data-item basis and checking if the variations of each data item are within a predetermined range. In a case where the difference is not less than the preset value, the first segment of the acquired data pieces is stored. On the other hand, in a case where the difference is less than the preset value, the second portion of the first segment of the acquired data pieces is stored. Hence, less data is stored if the acquired data does not contain any abnormality, whereas detailed data is stored if the acquired data contains some abnormality. Thus, the saving of storage space may be achieved while maintaining the accuracies of the stored data. Furthermore, in the case where the acquired data contains abnormality, the premonitory phenomenon preceding the occurrence of abnormality in the apparatus may be detected because the detailed data is stored.

### BRIEF DESCRIPTION OF THE DRAWINGS

FIG. 1 is a schematic perspective view showing an exemplary substrate processing apparatus wherein a data logging method according to an embodiment of the invention is performed.

FIG. 2 is a schematic side view of the substrate processing apparatus.

FIG. 3 is a skeleton framework explanatory of the data logging method according to the embodiment of the invention.

FIG. 4 shows an exemplary log data table produced by the data logging method.

FIG. 5 is a table listing admissible values based on which abnormality of data in the log data table is determined.

FIG. 6 illustrates an exemplary setting screen displayed on an operation screen, FIG. 6(a) showing an exemplary setting screen for acquiring the log data, FIG. 6(b) showing an exemplary screen indicating detailed information on individual items.

### DESCRIPTION OF REFERENCE CHARACTERS

1: wafer
2: pod
3: housing
4: front wall
5: front maintenance entrance
6: front maintenance door
7: pod delivery stage
8: pod entrance/exit
9: front shutter
11: rotary pod rack
12: support
13: shelf board
18: pod transporting machine
19: pod elevator
21: pod transporting mechanism
22: pod opener
23: internal housing
24: front wall
25: wafer entrance/exit
26: mounting table
27: capping/decapping mechanism
28: conveyance chamber
29: wafer conveying mechanism
31: wafer conveyer
32: wafer conveyer elevator
33: tweezers
34: boat
35: standby station
36: processing furnace
37: furnace port shutter
38: boat elevator
39: elevator arm
41: seal cap
43: clean air
44: clean unit
46: substrate processing apparatus
47: control unit
48: data logging device
49: operation portion
51: logging CPU
52: log data storage portion
53: external memory

### BEST MODE FOR CARRYING OUT THE INVENTION

The best mode for carrying out the invention will hereinbelow be described with reference to the accompanying drawings.

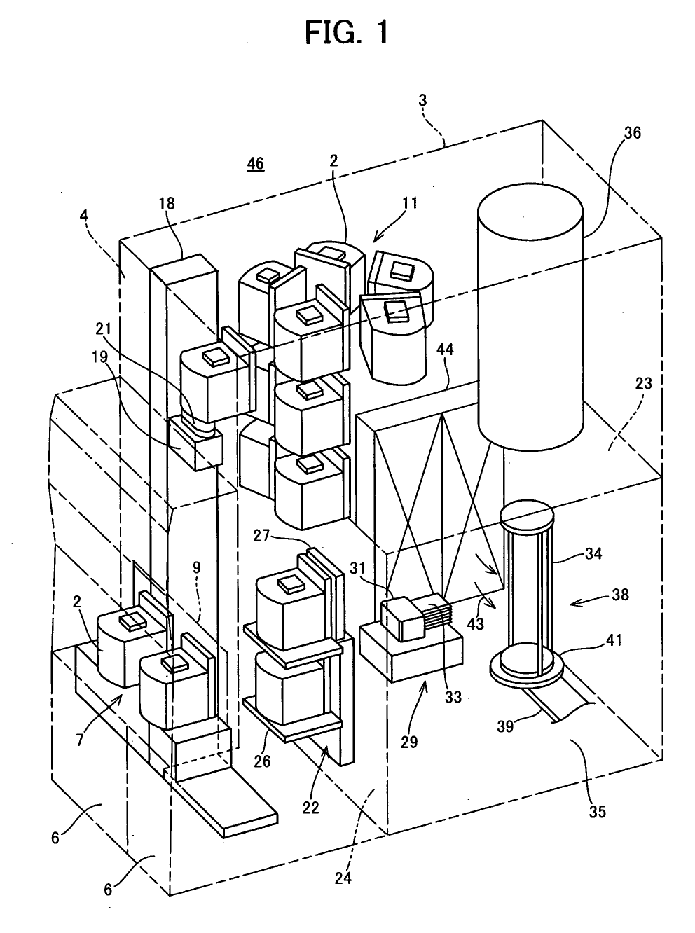

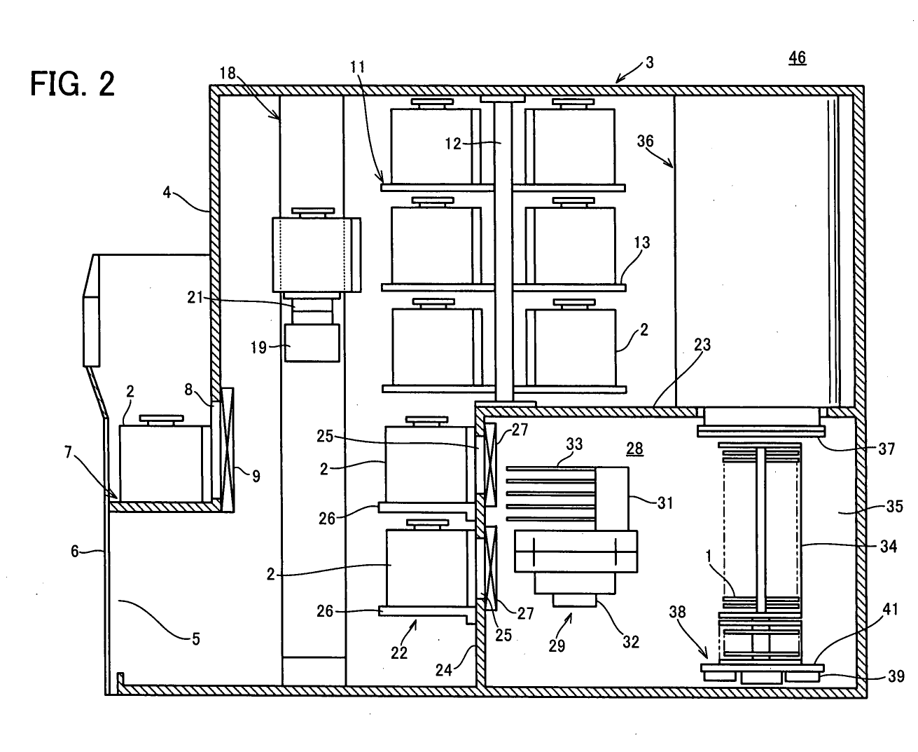

First referring to FIG. 1 and FIG. 2, description is made on a substrate processing apparatus 46 wherein the invention is carried out.

In the substrate processing apparatus 46, a wafer 1 is contained in a hermetically sealed substrate case (hereinafter, referred to as pod 2) so as to be stored or transported.

Indicated at 3 in FIG. 1 and FIG. 2 is a hermetically sealed housing. A front maintenance entrance 5 for maintenance service is formed at a lower part of a front wall 4 of the housing 3. The front maintenance entrance 5 is so arranged as to be opened or closed by means of a front maintenance door 6.

The front wall 4 is provided with a pod delivery stage (substrate case delivery stage) 7 at place upward of the front maintenance door 6. The pod delivery stage 7 is communicated with the interior of the housing 3 via a pod entrance/exit (substrate case entrance/exit) 8, which is opened or closed by means of a front shutter (substrate case entrance/exit opening/closing mechanism) 9.

An external transport machine (not shown) transports and delivers the pod 2 to the pod deliver stage 7.

A rotary pod rack (substrate case carrying rack) 11 is disposed in the housing 3 at an upper part of a substantially central portion thereof with respect to the fore-aft direction thereof. The rotary pod rack 1 is arranged to store the plural pods 2.

The rotary pod rack 11 includes: a support 12 disposed upright and intermittently driven into rotation; and a plurality of shelf boards (substrate case carrying boards) 13 extending radially of the support 12 as arranged in upper, intermediate and lower tiers. The plural pods 2 are carried on the plural shelf boards 13 in one-on-one relation.

A pod transporting machine (substrate case transporting machine) 18 is disposed between the pod delivery stage 7 and the rotary pod rack 11. The pod transporting machine 18 includes: a pod elevator (substrate case elevating mechanism) 19 capable of moving up or down as retaining the pod 2 thereon; and a pod transporting mechanism (substrate case transporting mechanism) 21 as a transport mechanism. The pod transporting machine 18 is arranged such that the pod elevator 19 and the pod transporting mechanism 21 work in cooperation to transport the pod 2 between the pod delivery stage 7 and the rotary pod rack 11, between the rotary pod rack 11 and a pod opener 22 (substrate-case cap-member opening/closing mechanism) 22 to be described hereinlater or between the pod opener 22 and the pod delivery stage 7.

An internal housing 23 including a hermetically sealed casing is disposed in the housing 3 at a lower part of the substantially central portion thereof with respect to the fore-aft direction thereof. The internal housing 23 extends from the substantially central portion to a rear end of the housing 3. A front wall 24 of the internal housing 23 is formed with a pair of wafer entrances/exits (substrate entrance/exit) 25 through which the wafers 1 are brought into or discharged from the internal housing 23. The wafer entrances/exits 25 are vertically disposed in tiered relation and are provided with the pod openers 22, 22, respectively.

The pod opener 22 includes: a mounting table 26 for mounting the pod 2 thereon; and a capping/decapping mechanism (cap-member attaching/detaching mechanism) 27 for attaching or detaching a cap (cap member) to or from the pad 2. The pod opener 22 is arranged to operate the capping/decapping mechanism 27 for attaching or detaching the cap of the pod 2 mounted on the mounting table 26, thereby opening or closing a wafer access opening of the pod 2.

The internal housing 23 constitutes a hermetically sealed conveyance chamber 28. A wafer conveying mechanism (substrate conveying mechanism) 29 is disposed at a forward region of the conveyance chamber 28. The wafer conveying mechanism 29 includes: a wafer conveyer (substrate conveyer) 31 capable of rotating and advancing or retreating the wafer 1 in the horizontal direction; and a wafer conveyer elevator (substrate-conveyer elevator mechanism) 32 for vertically moving the wafer conveyer 31.

The wafer conveying mechanism 29 is disposed in opposing relation with the wafer entrance/exits 25 and is arranged such that the wafer conveyer elevator 32 and the wafer conveyer 31 cooperate with each other whereby the wafer 1 is charged in or discharged from a boat (substrate retainer) 34 by means of tweezers (substrate retaining member) 33 of the wafer conveyer 31.

A rearward region of the conveyance chamber 28 defines a standby station 35 where the boat 34 is retained and placed in a standby state. A processing furnace 36 is disposed upwardly of the standby station 35. A furnace port at a lower end of the processing furnace 36 is adapted to be openably closed by means of furnace port shutter (furnace-port opening/closing mechanism) 37.

A boat elevator (substrate-retainer elevator mechanism) 38 for removably loading the boat 34 in the processing furnace 36 is disposed downwardly of the processing furnace 36. An elevator arm 39 of the boat elevator 38 is horizontally provided with a seal cap 41 as a furnace port closure. The seal cap 41 vertically supports the boat 34 and is adapted to hermetically close the furnace port.

The boat 34 includes a plurality of retaining members and is arranged to retain a plural number (say, 50 to 29 pieces) of wafers 1 in plural horizontal tiers.

A clean unit 44 is disposed in opposing relation with the wafer conveyer elevator 32. The clean unit includes a blower fan and a dust-proofing filter such as to feed a clean air 43 as a purified atmosphere or inert gas into the conveyance chamber 28. Although not shown in the figure, a notch aligner as a substrate aligner for alignment of the circumferential positions of the wafers is disposed between the clean unit 44 and the wafer conveyer 31.

The clean air 43 outputted from the clean unit 44 is allowed to flow to the notch aligner (not shown), the wafer conveyer 31 and the boat 34 at the standby station 35 and then, is drawn through an unillustrated duct to be discharged from the housing 3. Otherwise, the clean air 43 is circulated to a primary side (air supply side) as an intake side of the clean unit 44 so as to be outputted again into the conveyance chamber 28 by the clean unit 44.

Next, the operation of the apparatus is described.

When the pod 2 is supplied to the pod delivery stage 7, the pod entrance/exit 8 is opened by the front shutter 9 so that the pod 2 on the pod delivery stage 7 is transported through the pod entrance/exit 8 into the housing 3 by means of the pod transporting machine 18.

The pod 2 thus brought into the housing is carried by the pod transporting machine 18 so as to be placed on an specified one of the shelf boards 13 of the rotary pod rack 11 and stored temporarily. Thereafter, the pod 2 is transferred from the shelf board 13 to one of the pod openers 22 where the pod is placed on the mounting table 26. Otherwise, the pod transporting machine 18 may transport the pod 2 directly to the pod opener 22 and place the pod on the mounting table 26. In this process, the wafer entrances/exits 25 are closed by the capping/decapping mechanism 27, while the conveyance chamber 28 is filled with the clean air 43 flowing therethrough. For instance, the conveyance chamber 28 is filled with a nitrogen gas as the clean air 43 so that the conveyance chamber has an oxygen concentration set to 20 ppm or less, which is much lower than that of the interior (room air atmosphere) of the housing 3.

The pod 2 placed on the mounting table 26 has its opening-side end-face pressed against a circumferential portion of an opening of the wafer entrance/exit 25, while the capping/decapping mechanism 27 detaches the cap from the pod 2 so as to open the wafer access opening of the pod.

When the pod 2 is opened by means of the pod opener 22, the wafer 1 in the pod 2 is picked up by the tweezers 33 via the wafer access opening and is aligned by means of the notch aligner (not shown). Subsequently, the wafer 1 is transported to the standby station 35 at the rear portion of the conveyance chamber 28 and charged in the boat 34. After charging the wafer in the boat 34, the wafer conveyer 31 returns to the pod 2 for charging the subsequent wafer 1 in the boat 34. While the wafer conveying mechanism 29 is performing a wafer charging operation for charging a pod 2, retained on the upper or lower pod opener 22, in the boat 34, the pod transporting machine 18 transfers another pod 2 from the rotary pod rack 11 to the other (lower or upper) pod opener 22 so that the pod opener 22 may concurrently perform the operation of opening the pod 2.

When a previously specified number of wafers 1 are charged in the boat 34, the furnace port closed by the furnace port shutter 37 is opened by the furnace port shutter 37. Subsequently, the boat 34 is moved up by the boat elevator 38 and loaded in the processing furnace 36.

After loading, the wafers 1 are heated to a predetermined temperature while a processing gas suitable for the processing is introduced into a process chamber in the processing furnace 36. The wafers 1 are subjected to the predetermined processing in the processing furnace 36 wherein a flow rate of the introduced gas is maintained at a predetermined level and the pressure in the process chamber is maintained at a predetermined level.

When the processing is done, the wafers 1 and pods 2 are discharged from the housing 3 by reversing the aforementioned procedure excluding the wafer aligning step by means of the notch aligner (not shown).

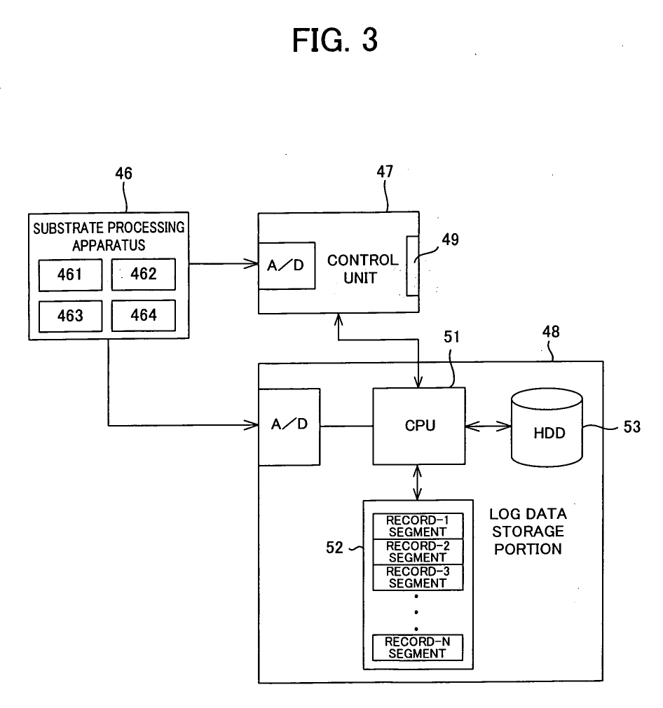

Next, a substrate processing system according to the invention is described with reference to FIG. 3.

The substrate processing system includes: the substrate processing apparatus 46; a control unit 47; a data logging device 48 and the like. The substrate processing apparatus 46, the control unit 47 and the data logging device 48 are interconnected vie lines such as LAN or LON so as to be able to communicate data with one another. FIG. 3 illustrates the control unit 47 and the data logging device 48 as discrete devices. However, the control unit 47 may be imparted with a data logging function and hence, the control unit 47 and the data logging device 48 may also be unified into a single device.

The substrate processing apparatus 46 includes: a mass flow controller (MFC) 461 for controlling the flow rate of the processing gas, the flow rate of a purge gas or the like; a pressure controller (APC) 462 for controlling the pressure in the process chamber; a pressure sensor for detecting the pressure in the process chamber; a temperature controller 463 for controlling the heating temperature of the wafers; a temperature sensor for detecting the temperature in the process chamber; and the like. A gas flow value detected by the mass flow controller, a pressure value detected by the pressure sensor and a temperature value detected by the temperature sensor are each subjected to signal processing including amplification and A/D conversion. The resultant signals are outputted to the control unit 47 and the data logging device 48.

The control unit 47 administratively controls the substrate processing apparatus 46 according to a set recipe. The control unit 47 includes: a conveyance controller 464 for controlling the pod transporting machine 18, the pod openers 22, the wafer conveyer 31, the boat elevator 38 and the like; the pressure controller 462; the mass flow controller 461; the temperature controller 463 and the like.

The data logging device 48 includes: a logging CPU 51; a log data storage portion 52 as an internal memory device including a semiconductor memory or the like; and an external memory 53 including an HDD or the like. The log data storage portion 52 is adapted to store a required number of log data pieces. Provided that a log data piece acquired at a time is referred to as one data record, the log data storage portion is adapted to store n data records, say 10 data records. The log data storage portion is further adapted to temporarily store a record indicative of a predetermined admissible value which is compared with an arithmetic value indicative of the variations of the log data. An operation portion 49 includes an operation screen such as to receive an instruction via unillustrated input means. When the log data pieces collected by the log data storage portion 52 are stored in the external memory 53, a cycle to assess the log data pieces is defined. While the details of the definition of the assessing cycle will be described hereinlater, the other logging conditions are defined via the operation screen.

The external memory 53 contains a log-data processing program for acquiring a variety of data items from the substrate processing apparatus 46 and the control unit 47, writing/reading data to/from the logging CPU 51, carrying out data transmission between the log data storage portion 52 and the external memory 53, processing the log data and such. The external memory is further adapted to store the log data processed by the processing program.

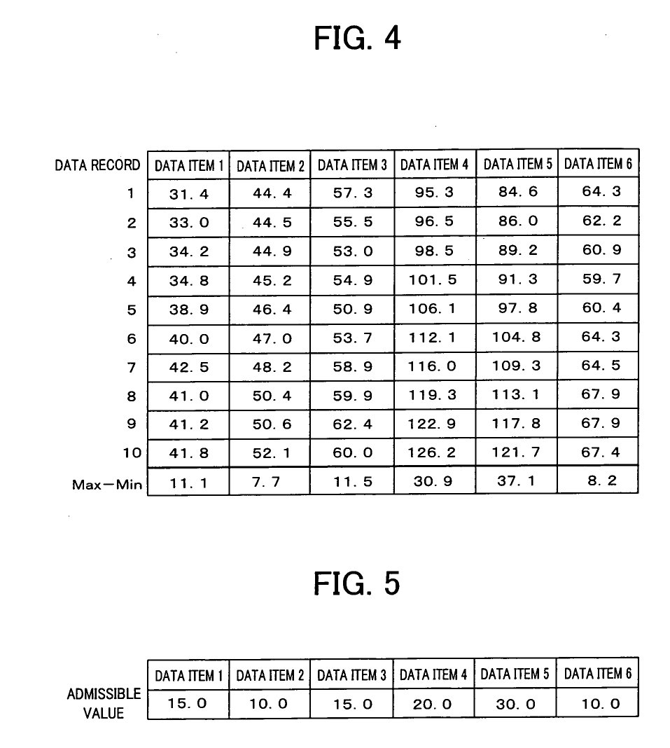

An example of the processing performed by the substrate processing system will be described in details with reference to FIG. 4 to FIG. 6.

In the following exemplary processing, it is assumed that a log-data acquiring cycle is one second and the number of stored data records is ten.

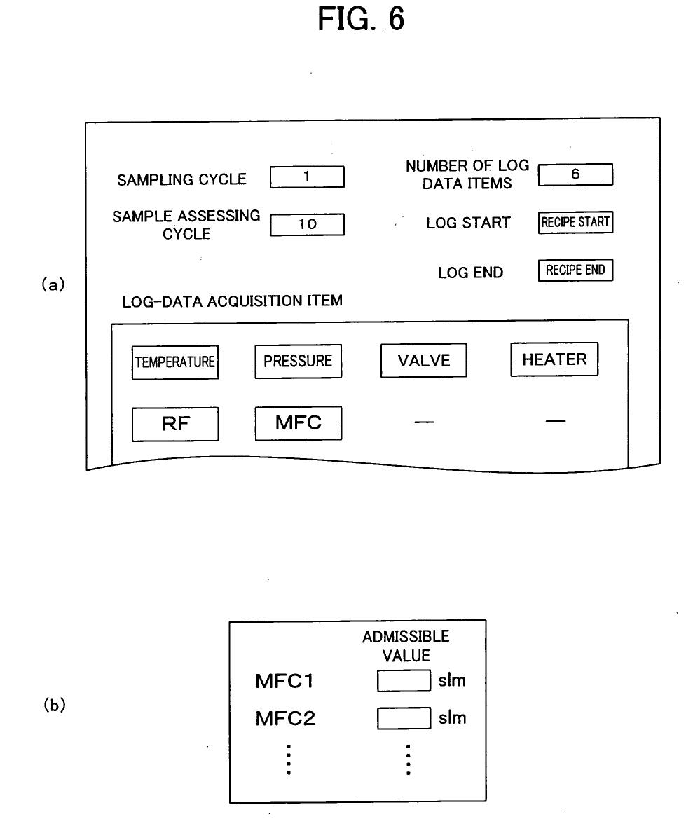

It is noted that log-data acquiring conditions including the log-data acquiring cycle, log-data acquisition item and the like are previously set via a setting screen provided at the operation portion 49 of the control unit 47. The log data setting is described in details with reference to FIG. 6.

FIG. 6 (a) shows an example of the setting screen for log data acquisition. According to the example, the setting screen indicates that a sampling cycle equivalent to the log-data acquiring cycle is set to one second and a sample assessing cycle equivalent to the cycle to assess the log data pieces acquired in the log data storage portion 52 is set to ten seconds. According to the example, one data record is acquired in each sampling cycle (one second) and hence, the log data is assessed in each sample assessing cycle (ten seconds) or for each set of ten data records. The sampling cycle and the sample assessing cycle may be arbitrarily set via the setting screen. While the sample assessing cycle is set on the basis of time, the cycle may also be set based on the number of data pieces.

The setting screen also permits the setting of the other conditions including the number of data items, log start condition, log end condition, data acquisition item and the like. While the setting example is made such that the log start is at the time of recipe start and the log end is at the time of recipe end, the setting is not particularly limited to this and may also be made on the basis of time, for example. An upper limit of the number of data items is decided because of the capabilities of the control unit 47 and the log data storage portion 52. While FIG. 6(a) indicates temperature, pressure, MFC, valve, heater, RF and the like as the data acquisition items, these data items may be changed or any other data item may be added. The data items may be changed according to the type of film, processing mode (CVD, diffusion, oxidization, etc.), for example. Each of these data items per se is implemented in a button. Pressing an MFC button, for example, an on-screen display as shown in FIG. 6(b) appears.

In FIG. 6(b), detailed information on each data item is displayed, including at least a title of the data item and an admissible value. An admissible value of a data item to be logged is inputted in a cell. Combinations of data items to be logged may be freely selected because the admissible value is defined on a per-item basis. According to this example, only the title and the admissible value are displayed as the detailed information on the item. However, it is also possible to display, for example, the title, the maximum admissible value, the minimum admissible value, a preset value (the maximum admissible value-the minimum admissible value) and the like. The operation portion may also be adapted to display not only the title and admissible value but also a set value and monitor value (current value) as detailed information.

In a case where the plural setting screens of the example are provided, the log start condition is made different from the log end condition whereby as to the temperature during the substrate processing, for example, the logging condition during a temperature rise period or during a high temperature period may be made different from the logging condition during a stable temperature period. Namely, an optimum logging may be accomplished by increasing the number of log data pieces acquired during the temperature rise or high temperature period and shortening the log-data assessing cycle and by reducing the number of log data pieces acquired during the stable temperature period and extending the log-data assessing cycle.

When the control unit 47 inputs a trigger signal to start logging to the logging CPU 51, the logging CPU 51 starts to acquire the data.

The logging CPU 51 acquires from the control unit 47 data to identify a substrate processing, which includes a current process mode (such as IDLE, RUN, STANDBY, ABORT), a title of an ongoing recipe and the like.

As the log-data items, data pieces on the supply flow rate of the processing gas, the processing pressure, the processing temperature and the like are acquired from the substrate processing apparatus 46 at a one-second interval.

The log data storage portion 52 has its data storage region divided into segments on a per-data-record basis. A log data piece acquired in the first cycle is stored in a record-1 segment, a log data piece acquired in the second cycle is stored in a record-2 segment and a log data piece acquired in the n-th cycle is stored in a record-n segment. Thus, the log data pieces acquired in ten cycles are stored in the log data storage portion 52. The ten log data pieces constitute a log data table as shown in FIG. 4. Incidentally, the log data table does not include a data record indicative of the arithmetic value of (MAX-MIN).

FIG. 4 illustrates a case where the log data on six data items are acquired.

When the acquisition of data on the all data items of the log data table is completed, the maximum value and the minimum value are retrieved from each of the data items and a difference between the maximum value and the minimum value or an arithmetic value (MAX-MIN) is calculated. The admissible (MAX-MIN) value is previously set in the data logging device 48 (see FIG. 5) so that the arithmetic value (MAX-MIN) thus determined is compared with the admissible (MAX-MIN) value. It is noted here that the data record indicative of the arithmetic value (MAX-MIN) may be listed below the data record indicative of a set value of the admissible (MAX-MIN) value shown in FIG. 5.

If the comparison indicates that all the arithmetic values (MAX-MIN) are less than the admissible (MAX-MIN) values, it is determined that the log data pieces in the log data table are stable. Hence, only the log data piece in the leading record-1 segment of the log data table, for example, is written to the external memory 53. It is noted that the record segment, the log data piece of which is to be written, may be properly selected only the log data piece of the record-3 segment or of the record-10 segment, for example, may be written so long as the log data piece is retrieved from a fixed record segment. In the case where the number of record segments is n, a constitution may be made such that the log data pieces from m record segments are written to the external memory 53, provided that m is an integer of 2 or more. An alternative constitution may be made such that a mean value of the acquired data pieces on each item or a log data piece having the closest value to the mean value is written to the external memory 53.

In the case of the stable log data, therefore, the amount of data stored in the external memory 53 is reduced to 1/10 or m/n.

When the determination on the abnormality of the log data in the log data storage portion 52 is completed and the log data in question is outputted to the external memory 53, all the data in the log data storage portion 52 is deleted so that the log data storage portion may continue to acquire log data. Therefore, the eleventh log data piece of the overall log data acquired in the process is written to the record-1 segment of the log data storage portion 52.

Log data pieces are acquired in the subsequent set of 10 cycles in the same manner and a log data table is prepared. The arithmetic value (MAX-MIN) is calculated on a per-data-item basis and then is compared with the admissible (MAX-MIN) value.

In a case where the comparison results indicate that any of the data items has an arithmetic value (MAX-MIN) above the admissible (MAX-MIN) value, all the data pieces of the log data table are outputted to the external memory 53. In the example shown in FIG. 4, the arithmetic values (MAX-MIN) of data items 4 and 5 exceed the admissible values. Hence, all the log data pieces except for the data records indicative of the arithmetic values (MAX-MIN) are written to the external memory 53.

In the case of instable log data, therefore, detailed data may be stored in the external memory 53.

A constitution may also be made such that if the arithmetic value (MAX-MIN) exceeds the admissible value, some of the log data pieces of each data item, that includes the maximum value and the minimum value, are written to the external memory 53 instead of writing all the data pieces of the log data table. For instance, data pieces in odd-numbered record segments including the leading record segment may be written. This constitution also permits the detailed log data to be stored in the event of the acquisition of abnormal data. Further, an alternative constitution may also be made such that all the data pieces only of a data item containing abnormal data are written to the external memory 53. In this case, the log data pieces of the other data items are normal and hence, for example, only the data piece of the leading record segment may be written to the external memory 53.

When the data in the log data storage portion 52 is outputted to the external memory 53, all the data in the log data storage portion 52 is deleted so that the log data storage portion may continue to acquire log data again. Such a log data acquisition is continued till a log-end trigger signal for ending the logging is inputted from the control unit 47.

According to the aforementioned example, while the substrate processing apparatus 46 operates normally, the log data is acquired at the one-second interval and the data is stored at the ten-second interval so that the amount of stored data is decreased to 1/10. The example defines the sampling cycle (the log-data acquiring cycle) as one second and the log-data assessing cycle as the log-data acquiring cycle (one second)×the number of data records (10)=10 seconds. However, the invention is not limited to this and any setting may be made. Further, it is also possible to make plural log data tables for respective data items. For instance, plural log data tables such as a log data table only for temperature and a log data table only for gas flow rate may be made. This provides for a more exact determination of data abnormality.

There may be a case where the log data from the substrate processing apparatus 46 temporarily presents an abnormal value but the abnormal value falls below an alarm detection level so that an alarm condition is not detected. Even in such a case, the log data table containing the abnormal value is recorded by the data logging device 48 and hence, detailed data on a premonitory phenomenon preceding the occurrence of the alarm condition may be obtained.

If a log data processing is constituted such that all the log data pieces are stored in the external memory 53 and the log data processing is performed on the log data pieces so stored, the amount of data is so great that the processing takes so much time as to disable the logging to be started while the substrate processing is going on.

However, the invention is constituted such that the log data processing is performed on each log data table showing a set of data pieces acquired from the apparatus based on the sample assessing cycle and that the processed data is stored in the external memory 53. Therefore, the invention reduces the process time and permits the substrate processing to be carried on without suspending the logging operation. Thus is obviated the decrease of throughput of the overall apparatus.

Next, handling of the acquired log data is described. When the substrate processing apparatus is in a proper, stable working condition, a log data file has a minimum volume. If the log data contains an abnormality, the log data file is increased in volume. Therefore, the log data file containing abnormality may be identified simply by checking the volume of the log data file. This negates the need for opening each log data file for checking the individual log data pieces thereof. Hence, it is possible to figure out in what processing or in which step of the processing the apparatus has fallen out of the proper, stable working condition. Accordingly, it is unnecessary for processing an irrelevant log data file (a log data file obtained when the apparatus operates normally) in the analysis of abnormality. An analysis operation is notably increased in efficiency.

Further, if a provision is made to collectively record the respective maximum values or minimum values of the data items of the log data table, the recorded data makes it possible to infer a tendency toward abnormality and may also be used as data for failure prognosis.

The substrate processing includes a variety of processes which include: a film deposition process such as CVD, PVD, oxide film deposition and nitride film deposition; an annealing process; an oxidizing process; a nitriding process; a diffusion process and the like. The substrate to be processed is not limited to the silicon wafer but also includes wafers of other materials and a glass substrate.

Therefore, the substrate processing apparatus of the invention is also applicable to semiconductor manufacturing equipment wherein a semiconductor substrate (silicon wafer and the like) is processed, or LCD manufacturing equipment wherein the glass substrate is processed.

Needless to say, the invention is applicable not only to the semiconductor manufacturing equipment but also to the sequential logging of the working condition of various apparatuses.

### Appendant

The invention includes the following embodiments.

### Appendant 1

A substrate processing apparatus characterized by including: detection means for detecting data (substrate temperature, gas flow rate, pressure in process chamber during film deposition) when a substrate is processed; storage means for temporarily storing the data acquired from the detection means; recording means for recording at least one of the data items stored in the storage means; and control means which determines a difference between the maximum value and the minimum value with respect to the data stored in the storage means and compares the difference with a preset value, which outputs to the recording means at least a first segment of the data stored in the storage means if the difference is not less than the preset value and which outputs to the recording means a second portion included in the first segment of the data stored in the storage means if the difference is less than the preset value.

### Appendant 2

A substrate processing system characterized by including: a substrate processing apparatus for processing a substrate; a first storage portion which temporarily stores data acquired from the substrate processing apparatus and in which the data is deleted when the data is outputted therefrom; a second storage portion for storing at least one of the data items stored in the first storage portion; and data processing means which determines a difference between the maximum value and the minimum value of the data pieces stored in the first storage portion, which outputs to the second storage portion a first segment of the data stored in the first storage portion if the difference is not less than a preset value, and which outputs to the second storage portion a second portion included in the first segment of the data stored in the first storage portion if the difference is less than the preset value.

### Appendant 3

A data logging device characterized by including: a first storage portion which temporarily stores acquired data and in which the data is deleted when the data is outputted therefrom; a second storage portion for storing at least one of the data items stored in the first storage portion; and data processing means which determines a difference between the maximum value and the minimum value of the data pieces stored in the first storage portion, which outputs to the second storage portion a first segment of the data stored in the first storage portion if the difference is not less than a preset value, and which outputs to the second storage portion a second portion included in the first segment of the data stored in the first storage portion if the difference is less than the preset value.

### Appendant 4

A data logging method characterized in that a difference between the maximum value and the minimum value of acquired data pieces is determined; that a first segment of the acquired data is stored if the difference is not less than a preset value; and that if the difference is less than the preset value, a mean value of the acquired data is determined and the mean value is stored.

1. A substrate processing apparatus characterized by including: detection means for detecting data when a substrate is processed; storage means for temporarily storing the data acquired from the detection means; recording means for recording at least one of the data items stored in the storage means; and control means which determines a difference between the maximum value and the minimum value and compares the difference with a preset value, which outputs to the recording means at least a first segment of the data stored in the storage means if the difference is not less than the preset value and which outputs to the recording means a second portion included in the first segment of the data stored in the storage means if the difference is less than the preset value.

2. A substrate processing system characterized by including: a substrate processing apparatus for processing a substrate; a first storage portion which temporarily stores data acquired from the substrate processing apparatus and in which the data is deleted when the data is outputted therefrom; a second storage portion for storing at least one of the data items stored in the first storage portion; and data processing means which determines a difference between the maximum value and the minimum value of the data pieces stored in the first storage portion, which outputs to the second storage portion a first segment of the data stored in the first storage portion if the difference is not less than a preset value, and which outputs to the second storage portion a second portion included in the first segment of the data stored in the first storage portion if the difference is less than the preset value.

3. A data logging device characterized by including: a first storage portion which temporarily stores acquired data and in which the data is deleted when the data is outputted therefrom; a second storage portion for storing at least one of the data items stored in the first storage portion; and data processing means which determines a difference between the maximum value and the minimum value of the data pieces stored in the first storage portion, which outputs to the second storage portion a first segment of the data stored in the first storage portion if the difference is not less than a preset value, and which outputs to the second storage portion a second portion included in the first segment of the data stored in the first storage portion if the difference is less than the preset value.

4. A data logging method characterized in that a difference between the maximum value and the minimum value of acquired data pieces is determined; and that a first segment of the acquired data pieces is stored if the difference is not less than a preset value, and if the difference is less than the preset value, a second portion included in the first segment of the acquired data pieces is stored.

5. A data logging method characterized in that data acquired from an apparatus is stored in a first storage portion; that a difference between the maximum value and the minimum value of the data pieces collected in the first storage portion at a predetermined time interval is determined; and that a first segment of the collected data pieces is stored in a second storage portion if the difference is not less than a preset value, and if the difference is less than the preset value, a second portion included in the first segment of the collected data pieces is stored in the second storage portion.

6. A data logging method characterized in that a time interval to permit a first storage portion to assess data acquired at least from an apparatus is defined; that a difference between the maximum value and the minimum value of the plural data pieces collected in the first storage portion at the time interval thus defined is determined; and that a first segment of the collected data pieces is stored in a second storage portion if the difference is not less than a preset value, and if the difference is less than the preset value, a second portion included in the first segment of the collected data pieces is stored in the second storage portion.

7. A data logging method characterized in that a cycle to acquire data at least from an apparatus and a time interval to permit a first storage portion to assess the data acquired from the apparatus are defined; that the data piece acquired in each cycle thus defined is stored in the first storage portion; that a difference between the maximum value and the minimum value of the plural data pieces stored in the first storage portion is determined at each time interval thus defined; and that a first segment of the collected data pieces is stored in a second storage portion if the difference is not less than a preset value, and if the difference is less than the preset value, a second portion included in the first segment of the collected data pieces is stored in the second storage portion.
